(19) United States
(12) Patent Application Publication
(10) Pub. No.: US 2010/0244386 A1
(43) Pub. Date: Sep. 30, 2010

(54) Labyrinth seal and method of producing a labyrinth seal

(75) Inventors: Peter Horling, Schonungen-Mainberg (DE); Sandra Kamm, Gochsheim (DE); Andreas Kern-Trautmann, Estenfeld (DE); Hans-Jürgen Liesegang, Schortens (DE); Reiner Wagner, Schwebheim (DE)

Correspondence Address: Mark A. Ussai;SKF USA Inc., 890 Forty Foot Road, PO Box 332, Kulpsville, PA, 19443, US

(73) Assignee: Aktiebolaget SKF, Goteborg (SE)

(21) Appl. No.: 12/658,885

(22) Filed: Feb. 17, 2010

(30) Foreign Application Priority Data
Feb. 17, 2009 (DE) 10 2009 009 226.9

(51) Int. Cl. F16J 15/447; F16C 33/72; F16C 33/80; B23P 17/04

(52) U.S. Cl. 277/417; 29/428

(57) ABSTRACT

A labyrinth seal includes a first disc and a second disc spaced axially from the first disc such that an axial intermediate chamber is formed between the first and the second discs. A first ring connected with the first disc so as to extend generally toward the second disc and into the axial chamber and second and third rings are each connected with the second disc so as to extend generally toward the first disc and into the axial chamber. The third ring is spaced radially outwardly from the second ring and the first ring being at least partially disposed radially between the second and third rings so as to form a sealing labyrinth. Preferably, each of the rings is cut from a common strip of material, bended to form a ring and welded to the associated disc.

The present application claims priority to German Patent Application No. 10 2009 009 226.9 filed on Feb. 17, 2009, the contents of which are fully incorporated herein by reference.

The present invention relates to seals, more particularly to labyrinth seals for sealing bearings.

A labyrinth seals are generally known and can be used, for example, to seal off a housing with respect to a shaft. Sealing by means of a labyrinth seal has the advantage that the labyrinth seal is not subjected to wear, in contrast to a sliding seal. However, a labyrinth seal generally has a relatively complex shape because, to obtain a good sealing action, it is necessary to form as convoluted a path as possible, which is also referred to as a sealing labyrinth, between the regions to be sealed off with respect to one another. A sealing labyrinth may for example be realized by means of two or more complementarily formed components which engage one into the other in a comb-like manner. The components are produced in particular as plastic injection moulded parts.

A labyrinth seal formed in this way is known for example from DE 10 2005 059 847 B3. The known labyrinth seal has two plastic parts which rotate relative to one another and which are formed in each case in one piece and which are arranged axially adjacent to one another. The plastic parts have radially staggered axial projections which extend in each case over the entire circumference and which engage axially one into the other.

Labyrinth seals produced from plastic have duly proven their excellence. However, with increasing size, the limited rigidity and dimensional stability of the plastic parts used becomes an ever greater problem. For this reason, very large labyrinth seals are often produced from metal. For this purpose, the components are produced in particular in a cutting process from a solid material. It is duly possible to obtain a high degree of precision with such a production process. However, such a production process is comparatively complex and requires a high level of material usage.

DE 36 17 863 A1 discloses a labyrinth seal which, on a first side, has two concentric sleeves which are fastened to an intermediate ring. On a second side, the known labyrinth seal has two concentric angle profiles which are directly connected to one another. A labyrinth seal designed in this way can duly be produced with a lower level of material usage than a labyrinth seal machined from a solid material. However, production is still relatively complex and the dimensional accuracy achievable is insufficient for some applications.

### SUMMARY OF THE INVENTION

It is an object of the invention to design a labyrinth seal such that high demands on precision can be met and production is possible even in large dimensions with justifiable expenditure.

In one aspect, the present invention is a labyrinth seal comprising a first disc and a second disc spaced axially from the first disc such that an axial intermediate chamber is formed between the first and the second discs. A first ring is connected with the first disc so as to extend generally toward the second disc and into the axial chamber and second and third rings are each connected with the second disc so as to extend generally toward the first disc and into the axial chamber. The third ring is spaced radially outwardly from the second ring and the first ring is at least partially disposed radially between the second and third rings so as to form a sealing labyrinth.

In another aspect, the present invention is a bearing assembly for a wind power plant, the bearing assembly comprising a bearing and a labyrinth seal. The labyrinth seal includes a first disc and a second disc spaced axially from the first disc such that an axial intermediate chamber is formed between the first and the second discs. A first ring is connected with the first disc so as to extend generally toward the second disc and into the axial chamber and second and third rings are each connected with the second disc so as to extend generally toward the first disc and into the axial chamber. The third ring is spaced radially outwardly from the second ring and the first ring is at least partially disposed radially between the second and third rings so as to form a sealing labyrinth.

In a further aspect, the present invention is a method for producing a labyrinth seal comprising the steps of: providing a first disc, a second disc and an elongated sheet of material; cutting the sheet of material so as to form a first strip, a second strip, and a third strip; bending each of the first, second and third strips so as to form first, second and third rings; attaching the first ring to the first disc such that the first ring and the first disc are substantially coaxial; attaching the second and third rings to the second disc such that each of the second and third rings is substantially coaxial with the second disc and the third ring is disposed radially outwardly of the second ring; and positioning the first and second discs such that the two discs are spaced axially apart and the first ring is disposed at least partially radially between the second and third rings so as to form a sealing labyrinth.

More specifically, the labyrinth seal according to the present invention has a first disc and a second disc which is arranged at an axial distance from the first disc and which overlaps the first disc radially in regions, such that an axial intermediate chamber is formed between the first disc and the second disc. The labyrinth seal also has a first ring which is fastened to the first disc, a second ring which is fastened to the second disc and a third ring which is fastened to the second disc. The first disc, the second disc, the first ring, the second ring and the third ring are produced as separate components. The first ring extends from the first disc and the second ring and the third ring extend from the second disc into the axial intermediate chamber. The first ring, the second ring and the third ring overlap axially and thereby form a sealing labyrinth. The second ring is arranged radially inside the first ring and the third ring is arranged radially outside the first ring.

The labyrinth seal according to the invention has the advantage that it can be produced even in large dimensions with justifiable expenditure and with high precision. As a result of the high precision, it is possible to obtain a good sealing action. On account of a lack of contact between the parts which move relative to one another, no wear problems occur during the use of the labyrinth seal according to the invention.

If a relatively low sealing action is satisfactory, it is possible for either the second ring or the third ring to be dispensed with. It is however likewise possible for further rings to be fastened to the first disc and/or to the second disc.

At least one of the discs and at least one of the rings may be connected to one another in a positively locking and/or bonded manner. A bonded connection has the advantage that it can be realized in a cost-effective manner and is very durable. In particular, the bonded connection may be a welded connection, which is produced preferably by means of a laser beam. A positively locking connection facilitates handling during production and can be subjected to extremely high loadings.

At least one of the rings may have axial projections which engage into slots of at least one of the discs. In this way, it is possible to realize a positively locking connection of very simple design. The projections and the slots may in particular be of curved design.

The first disc preferably extends radially inwards from the radial overlap region of the discs and the second disc preferably extends radially outwards from the radial overlap region. This provides accessibility to both discs in the installed state of the labyrinth seal.

It is also advantageous if at least one of the discs and/or at least one of the rings is produced from a sheet of material. This enables cost-effective production. Sheet metal is a particularly suitable material. The discs and/or the rings may in particular have the same material thickness. Furthermore, at least one of the discs may have a central hole. It is preferable for both discs to have a central hole. Furthermore, at least one of the discs may have recesses for holding encoder devices. Said recesses may in particular be arranged radially adjacent to the radial overlap region of the discs. Encoder devices may be arranged in the recesses such that the labyrinth seal according to the invention can perform the function of an encoder, for example a rotational speed encoder, in addition to its sealing function.

The axial intermediate chamber between the discs may be filled with a lubricant, in particular with lubricating grease. In this way, it is possible to obtain a particularly good sealing action.

The labyrinth seal according to the invention is particularly suitable for use in large bearings. Accordingly, at least one of the discs may have an outer diameter of at least three-tenths of a meter (0.3 m), preferably at least one meter (1 m).

The present invention also relates to a bearing arrangement of a wind power plant having a labyrinth seal according to the invention.

The present invention also relates to a method for producing a labyrinth seal, in which a first disc, a second disc, a first strip, a second strip and a third strip are detached from an elongated sheet of material, the first strip is bent to form a first ring, the second strip is bent to form a second ring and the third strip is bent to form a third ring, and the first ring is fastened coaxially to the first disc and the second ring and the third ring are fastened coaxially to the second disc.

With the method according to the invention, it is possible to produce a labyrinth seal of complex design with high precision from a starting material which is of very simple design and which is cheaply available.

To produce a labyrinth seal with a relatively low sealing action, it is possible for either the second ring or the third ring and accordingly also the second strip or the third strip to be dispensed with. For a greater sealing action, it is possible for one or more additional rings to be fastened to the first and/or the second discs, such that a correspondingly greater number of strips are then also required.

The first disc, the second disc, the first strip, the second strip and/or the third strip may be produced from the same sheet of material. The more components are produced from the same sheet of material, the fewer different materials need to be stocked.

At least one of the strips is preferably detached from the an elongated sheet or strip of material in such a way that projections are formed on one of the longitudinal sides of said strip. The projections may serve for fastening purposes.

It is particularly advantageous for the strips to be detached from the sheet of material as adjacently-arranged structures with common separation lines. This approach saves material, processing time and tool costs.

The detachment from the sheet of material may be carried out in particular by means of a laser beam or by using any other appropriate cutting technique. Using the laser beam, contours can be formed cleanly and quickly with a low level of material usage.

Recesses for holding encoder devices may be formed in the second disc. The encoder devices can then be inserted into said recesses, and the labyrinth seal can thus perform an encoder function in addition to its sealing function. Furthermore, curved slots can be formed in the first disc and/or in the second disc. At least one of the rings can then be fastened to at least one of the discs by virtue of the projections of said ring being plugged into the slots of the disc. In this way, the respective ring is placed into a round shape in a very simple manner with a degree of precision predefined by the slots. Complex measurement and alignment processes may be dispensed with. It is additionally or alternatively possible for the ring to be fixed to the disc in particular in a material bonded manner (e.g., by welding, adhesives, etc).

The formation of the slots and/or the recesses for the encoder devices can be carried out by means of a laser beam. This may take place before or after the detachment from the sheet of material. In this working step, too, the use of a laser beam provides considerable advantages in relation to alternative methods. Using the laser beam, the desired contours can be generated with a very high degree of precision quickly and with relatively little expenditure. This has the result, for example, that the slots lay on a common circular line with a high degree of precision. It is therefore possible for the ring to be placed into a round shape with a very high degree of precision as the projections of the respective ring are plugged into the slots. The production of the slots by means of a laser beam, the plugging of the projections of the rings into the slots and the subsequent laser welding therefore constitute a virtually ideal combination by means of which the sealing labyrinth can be produced with a high degree of precision with little expenditure.

Provision may also be made for the discs to be arranged in plane-parallel fashion with respect to one another. In this way, a particularly high degree of precision can be obtained during the subsequent machining.

A bonded connection may be formed between the rings and the discs. The formation of the bonded connection may be carried out by means of a laser beam, in particular in the form of a laser welding process. In the present application, laser welding has the advantage over other welding processes that only a very short and very local temperature increase occurs, and therefore at most only slight warping occurs in the welded parts. Truing after the welding process is therefore dispensed with or can be reduced to a minimum. For a cost-effective and nevertheless precise production process, this aspect is very important. It is also advantageous for the bonded connection to be formed in each case on that side of the discs which faces away from the rings. Furthermore, provision may be made for bonded connections between the rings and the discs to be formed in the region of the slots in such a way that leakages through the slots are prevented. Bonded connections can also be formed between the encoder devices and the second disc. To prevent leakages through the recesses, provision may be made for the bonded connections to be formed in each case along the entire contours of the recesses.

For the sheet of material, it is possible in particular to use sheet metal, such as for example, a strip or coil of low carbon steel. Sheet metal has a high strength, can be easily machined and is cheaply available.

A coating may be formed on the surface of the sheet/strip of material before or after the detachment. The coating may in particular serve to prevent corrosion.

### BRIEF DESCRIPTION OF THE SEVERAL VIEWS OF THE DRAWINGS

The foregoing summary, as well as the detailed description of the preferred embodiments of the present invention, will be better understood when read in conjunction with the appended drawings. For the purpose of illustrating the invention, there is shown in the drawings, which are diagrammatic, embodiments that are presently preferred. It should be understood, however, that the present invention is not limited to the precise arrangements and instrumentalities shown. In the drawings:

FIG. 1 is an axial cross-sectional view of an exemplary embodiment of a bearing arrangement designed according to the invention, in a sectional illustration,

FIG. 2 shows an enlarged detail from FIG. 1,

FIG. 3 shows the detail illustrated in FIG. 2 in a side view,

FIG. 4 shows an exemplary embodiment of the environment-side component of the labyrinth seal in a sectional illustration,

FIG. 5 shows a partial region of the environment-side component, illustrated in FIG. 4, of the labyrinth seal in a side view,

FIG. 6 shows an exemplary embodiment of the ring in a side view,

FIG. 7 shows an exemplary embodiment of the bearing-side component of the labyrinth seal in a sectional illustration,

FIG. 8 shows the bearing-side component, illustrated in FIG. 7, of the labyrinth seal in a side view,

FIG. 9 shows the bearing-side component, illustrated in FIG. 7, of the labyrinth seal in a further side view, and

FIG. 10 shows a “snapshot” during the production of an exemplary embodiment of the labyrinth seal according to the invention in a schematic illustration.

### DETAILED DESCRIPTION OF THE INVENTION

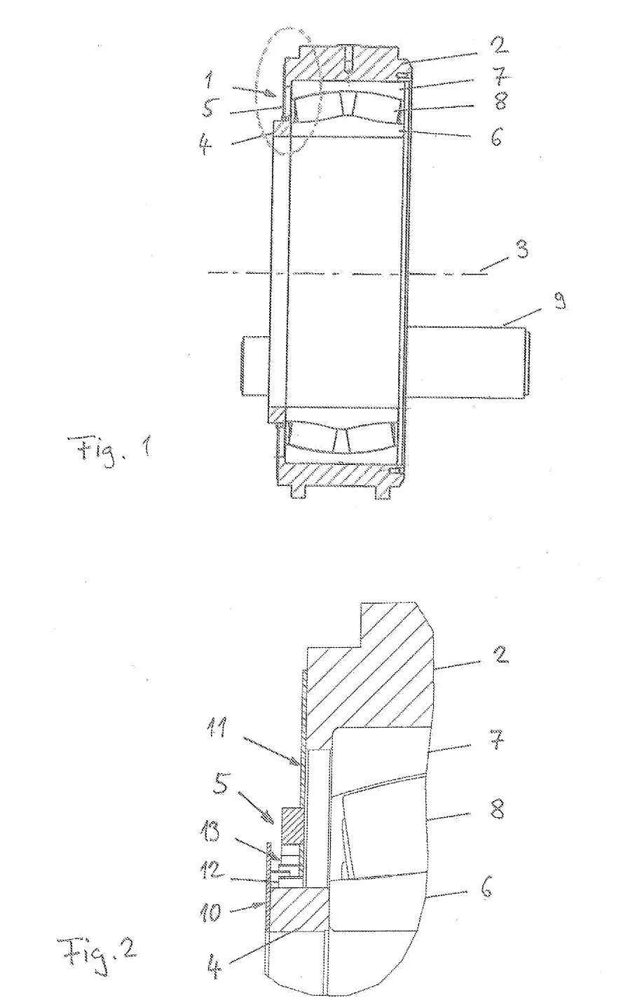

FIG. 1 shows an exemplary embodiment of a bearing arrangement designed according to the invention. The bearing arrangement has a rolling bearing 1 which, in the illustrated exemplary embodiment, is designed as a double-row spherical roller bearing. The rolling bearing 1 may for example also be designed as a double-row tapered roller bearing or have some other single-row or multi-row design. The rolling bearing 1 is arranged in a housing 2 and serves to mount a machine part which is not illustrated in the Figs., for example a shaft, such that said machine part is rotatable about an axis of rotation 3. The rolling bearing 1 may be fastened to the mounted machine part by means of a clamping nut 4. A labyrinth seal 5 attached to the housing 2 and to the clamping nut 4 seals off the bearing arrangement on one axial side. The axial direction is considered in each case to be a direction parallel to the axis of rotation 3 of the rolling bearing 1 unless stated otherwise.

The rolling bearing 1 has an inner ring 6, an outer ring 7 and rolling bodies 8 which roll between the inner ring 6 and the outer ring 7. The housing 2 has, for example, two axially extending bearers or brackets 9 for fastening in an installation environment.

The bearing arrangement according to the invention may have very large external dimensions, such that the labyrinth seal 5 may have an outer diameter of greater than three-tenths of a meter (0.3 m), and in certain applications greater than one meter (1 m). In the illustrated exemplary embodiment, the labyrinth seal 5 preferably has an outer diameter of 1.7 m and an inner diameter of 1.3 m. The rolling bearing 1 according to the invention may be used in particular for mounting a rotor shaft of a wind power plant.

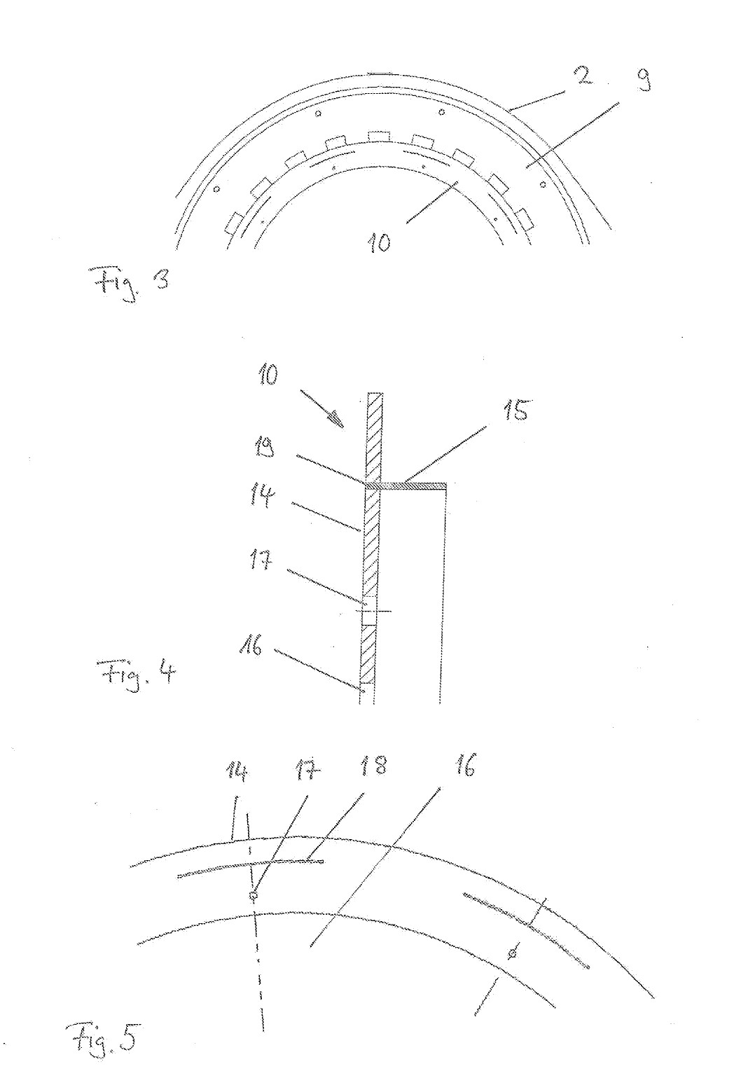

FIG. 2 shows an enlarged detail from FIG. 1 in the region of the labyrinth seal 5. A side view of said detail is illustrated in FIG. 3.

The labyrinth seal 5 has an environment-side component 10 and a bearing-side component 11 which are arranged axially adjacent to one another and which are rotatable relative to one another without coming into contact. The environment-side component 10 and the bearing-side component 11 of the labyrinth seal 5 overlap radially in regions and thereby delimit an axial intermediate chamber 12. Within the axial intermediate chamber 12, which may be filled with a lubricant (not depicted), in particular with lubricating grease, the environment-side component 10 and the bearing-side component 11 of the labyrinth seal 5 together form a sealing labyrinth 13.

The environment-side component 10 of the labyrinth seal 5 may be rotationally fixedly connected to the clamping nut 4 by means of a threaded fasteners, such as a screw connection (not illustrated in the Figs.) and is arranged further axially remote from the rolling bearing 1 than the bearing-side component 11. Furthermore, the environment-side component 10 of the labyrinth seal 5 has a smaller inner diameter and a smaller outer diameter than the bearing-side component 11. Details with regard to the design of the environment-side component 10 of the labyrinth seal 5 will be explained on the basis of FIGS. 4 to 6.

The bearing-side component 11 of the labyrinth seal 5 is rotationally fixedly connected to the housing 2, i.e., connected such that the seal 5 and housing 2 rotate as a single unit. The rotationally fixed connection may be realized for example by means of threaded fasteners such as screws (none depicted). Details with regard to the design of the bearing-side component 11 of the labyrinth seal 5 will be explained on the basis of FIGS. 7 to 9.

FIG. 4 shows an exemplary embodiment of the environment-side component 10 of the labyrinth seal 5 in a sectional illustration. FIG. 5 illustrates an associated side view of a partial region of the environment-side component 10 of the labyrinth seal 5.

The environment-side component 10 of the labyrinth seal 5 has a disc 14 and a ring 15 which is connected or fastened coaxially and perpendicularly to the disc 14. Preferably, the disc 14 and the ring 15 are each produced from an elongated sheet of material, such as a coil or strip of material, for example sheet metal (e.g., low carbon steel coil).

The disc 14 has a central bore or hole 16 and a plurality of openings 17 spaced equidistantly about a circumference (i.e., circumferentially spaced). Each opening 17 is configured to receive and retain a sensor or for fastening purposes. Furthermore, the disc 14 has a plurality of curved “slots” or slotted openings 18 which are distributed equidistantly about the circumference at about the same radius. With such slotted openings 18, the ring 15 engages into the slots 18 such that the ring 15 is located at a desired radius and positioned coaxially with respect the disc 14, and also fixed in a positively locking manner (i.e., interlocked) in the radial direction, as described in further detail below. The disc 14 is preferably fixedly connected with the ring 15, such as by means of a material bonded connection (e.g., by welding, braising, adhesives, etc.) formed between the disc 14 and the ring 15. Most preferably, the ring 15 is welded, for example by means of laser welding, to the disc 14 in the region of the slots 18. By means of a material bonded connection over the full area in the region of the slots 18, durable fixing of the ring 15 to the disc 14 is obtained and leakage through the slots 18 is prevented.

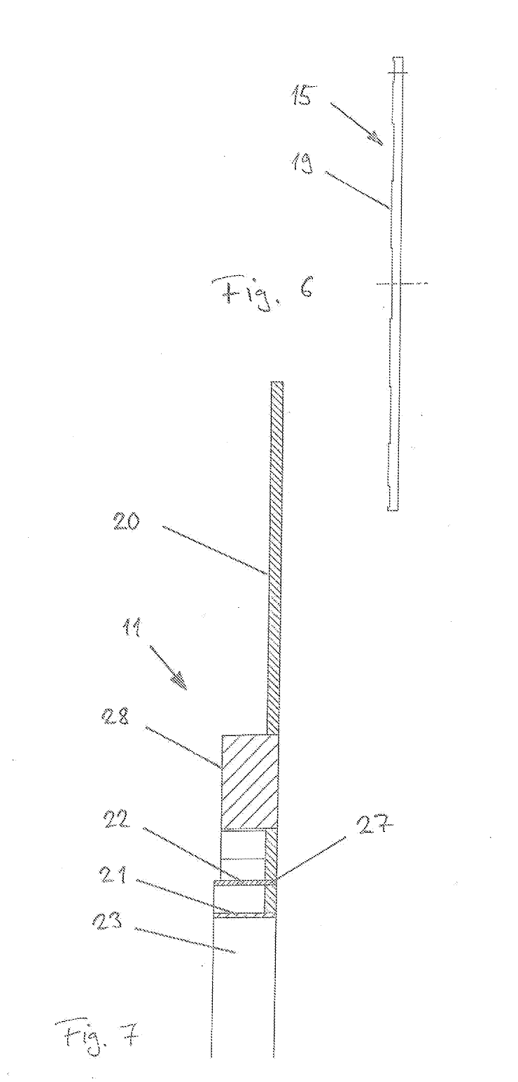

FIG. 6 shows an exemplary embodiment of the ring 15 in a side view. The ring 15 preferably has a plurality of circumferentially-spaced axial projections 19, each projection 19 being configured to engage with a separate one of the slotted openings 18 of the disc 14 (see, e.g., FIGS. 4 and 5), as described above.

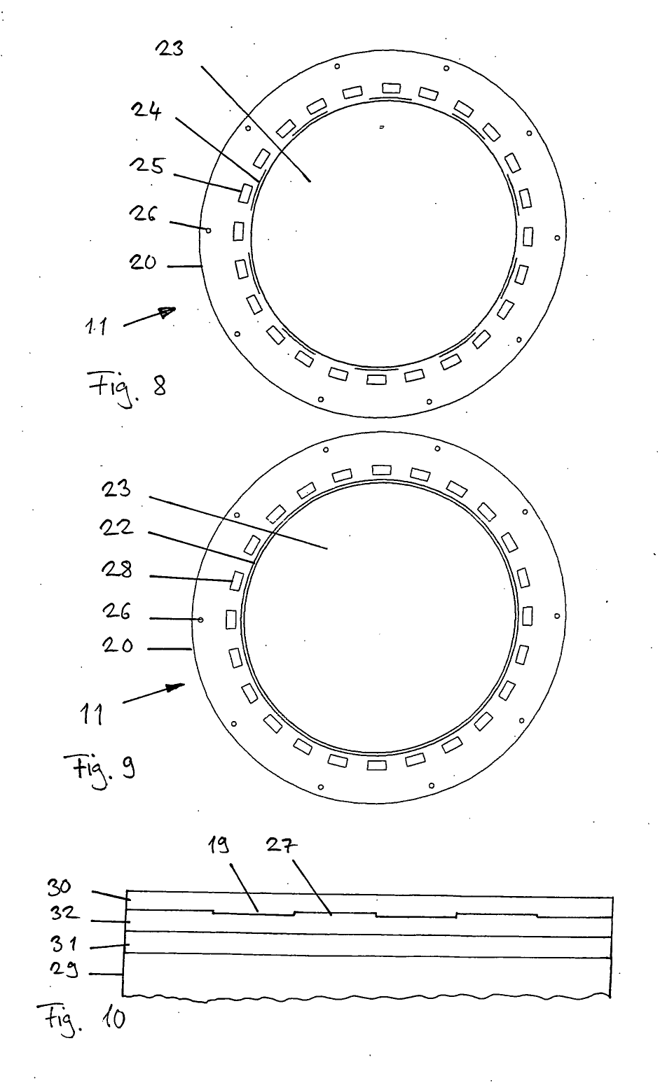

FIG. 7 shows an exemplary embodiment of the bearing-side component 11 of the labyrinth seal 5 in a sectional illustration. Associated side views of the bearing-side component 11 of the labyrinth seal 5 from mutually opposite sides are illustrated in FIGS. 8 and 9.

The bearing-side component 11 of the labyrinth seal 5 has a disc 20 and rings 21 and 22 fastened coaxially and perpendicularly to the disc 20, which rings 21 and 22 may be produced in each case from sheet metal or from a sheet or strip of another appropriate type of material.

The disc 20 has a central hole 23 and plurality of circumferentially-spaced curved slots/slotted openings 24, a plurality of circumferentially-spaced recesses 25 and a plurality of openings 26. In the region of the inner diameter of the disc 20, the ring 21 is fixedly attached, preferably materially bonded, to the disc 20. The ring 22 has a plurality of axial projections 27 each configured to engage with a separate one of the slotted openings 24 of the disc 20, and is preferably fixedly attached to the disc 20 in a positively locking and cohesive fashion, such as by means of weldment material.

The recesses 25 are spaced radially outwardly of the slotted openings 24 and radially inwardly of the openings 26, each recess 25 being configured to receive and retain a separate one of a plurality of encoder devices 28. The encoder devices 28 may be, for example, rotational speed encoders by means of which inductive, optical, or some other type of rotational speed measurement is carried out.

In the assembled state of the environment-side component 10 and the bearing-side component 11 of the labyrinth seal 5, the ring 15 of the environment-side component 10 is disposed at least partially between the rings 21 and 22 of the bearing-side component 11 and axially overlaps the rings 21 and 22. The sealing labyrinth 13 indicated in FIG. 2 is formed in this way. To obtain an even better sealing action, the sealing labyrinth 13 may be formed by additional rings (none depicted) of the environment-side component 10 and/or of the bearing-side component 11.

In a modification of the invention, discs 14, 20 may be formed without the slots 18, 24 and the rings 15, 22 may be formed without the projections 19, 27. In such a construction, the rings 15, 22 are, similarly to the ring 21, connected to the discs 14, 20 by means of butt joints (e.g., butt welding, braising, adhesives, etc).

Referring particularly to FIG. 10, the labyrinth seal 5 of the present invention is preferably formed in the following manner. FIG. 10 shows a “snapshot” during the production of the labyrinth seal 5 according to the invention in a schematic illustration. FIG. 10 illustrates a sheet or strip of material 29, for example a sheet-metal strip, which is preferably machined or cut by means of a laser beam, but may be cut by another other appropriate means, such a saw, a water jet, an electrical discharge machine, etc. Using the laser beam or other cutting means, a material strip 30, a material strip 31 and a material strip 32 are detached from the elongated sheet of material 29, from which strips the rings 15, 21, 22 are produced in further working steps. Accordingly, the material strips 30, 32 are of substantially rectangular design and have the projections 19, 27 in each case on one longitudinal side. The material strip 31 is likewise rectangular but has no projections.

To keep the material and time expenditure low, in each case two adjacent material strips, for example 30 and 32 or 32 and 31, are detached from the sheet of material 29 by means of a common separation line. This is made possible by virtue of in each case two longitudinal sides with projections 19, 27 or two longitudinal sides without projections 19, 27 adjoining one another in adjacent material strips, for example 30 and 32 or 32 and 31.

The discs 14, 20 can also be detached from the same sheet/strip of material 29. It is however also possible for the discs 14, 20 to be detached from a sheet or strip of material 29 which has a different, in particular greater material thickness. The central holes 16, 23, the slots 18, 24, the bores 17, 26 and the recesses 25 can be detached from the discs 14, 20 by means of the laser beam before or after the discs 14, 20 are detached from the material 29.

In a further method step, the material strips 30, 31, 32 are bent into a round shape such that the rings 15, 21, 22 are formed. Here, it is possible for the ends of the material strips 30, 31, 32 to be welded to one another in each case after the bending. The rings 15, 22 produced in this way are plugged with their projections 19, 27 into the slots 18, 24 of the discs 14, 20. The ring 21 is inserted slightly into the central hole 23 of the disc 20. The rings 15, 21, 22 are subsequently fixed by means of a laser beam to the rear side, that is to say to the sides in each case facing away from the rings 15, 21, 22, of the discs 14, 20. Furthermore, the encoder devices 28 are inserted into the recesses 25 of the disc 20 and are likewise fixed at the rear side by means of a laser beam. The insertion and fixing of the encoder device 28 may also take place before the assembly of the rings 15, 21 to the discs 14, 20.

The two discs 14, 20 are then clamped in plane-parallel fashion and, preferably by means of a laser beam, the rings 15, 21, 22 are welded to the discs 14, 20, in each case along the entire contour of the slots 18, 24, and each encoder devices 28 is preferably welded to the disc 20 along the entire contour of the associated recess 25. Thereby, leakages are prevented from occurring through the slots 18, 24 or recesses 25. Furthermore, as a result of the clamping during the welding process, a high degree of precision and in particular plane parallelism of the labyrinth seal 5 is ensured.

After the welding operation, the components 10, 11 of the labyrinth seal 5 can be subjected to a coating operation. Here, it is possible for example to produce a corrosion-preventing layer. The coating process may be for example the formation of an oxide coating or a painting process. It is likewise possible for the coating operation to be carried out already at an earlier point in time.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as generally defined in the appended claims.

We claim:

1. A labyrinth seal comprising:
a first disc;
a second disc spaced axially from the first disc such that an axial intermediate chamber is formed between the first and the second discs;
a first ring connected with the first disc so as to extend generally toward the second disc and into the axial chamber;
second and third rings each connected with the second disc so as to extend generally toward the first disc and into the axial chamber, the third ring being spaced radially outwardly from the second ring and the first ring being at least partially disposed radially between the second and third rings so as to form a sealing labyrinth.

2. The labyrinth seal as recited in claim 1 wherein the first disc, the second disc, the first ring, the second ring, and the third ring are each provided by a separate component, the separate components being assembled together to form the labyrinth seal.

3. The labyrinth seal as recited in claim 1 wherein at least one of the first, second and third rings is at least one of interlocked with and fixedly connected with the connected one of the first and second rings.

4. The labyrinth seal as recited in claim 1 wherein at least one of the first and second disc has a plurality of slotted openings and at least one of the first, second and third rings has a plurality of axial projections each disposed within a separate slotted opening of the at least one disc.

5. The labyrinth seal as recited in claim 1 wherein at least one of the first disc, the second disc, the first ring, the second ring and the third ring is formed from a material strip.

6. The labyrinth seal as recited in claim 1 wherein at least one of the first and second discs has a plurality of recesses, each recess being configured to retain an encoder device.

7. The labyrinth seal as recited in claim 1 wherein at least one of the first and second discs has an outside diameter of at least 0.3 meters.

8. A bearing assembly for a wind power plant, the bearing assembly comprising:
a bearing; and
a labyrinth seal including:
a first disc;
a second disc spaced axially from the first disc such that an axial intermediate chamber is formed between the first and the second discs;
a first ring connected with the first disc so as to extend generally toward the second disc and into the axial chamber;
second and third rings connected with the second disc so as to extend generally toward the first disc and into the axial chamber, the third ring being spaced radially outwardly from the second ring and the first ring being at least partially disposed radially between the second and third rings so as to form a sealing labyrinth.

9. A method for producing a labyrinth seal comprising the steps of:
providing a first disc, a second disc and an elongated sheet of material;
cutting the sheet of material so as to form a first strip, a second strip, and a third strip;
bending each of the first, second and third strips so as to form first, second and third rings;
attaching the first ring to the first disc such that the first ring and the first disc are substantially coaxial;
attaching the second and third rings to the second disc such that each of the second and third rings is substantially coaxial with the second disc and the third ring is disposed radially outwardly of the second ring; and
positioning the first and second discs such that the two discs are spaced axially apart and the first ring is disposed at least partially radially between the second and third rings so as to form a sealing labyrinth.

10. The method as recited in claim 9 wherein at least one of the first and second discs is cut from the sheet of material.

11. The method as recited in claim 9 wherein at least one of the first, second, and third strips is cut from the material such that projections are formed on longitudinal side of the at least one strip.

12. The method as recited in claim 9 wherein each one of the first, second and third strips is provided by a separate one of section of the sheet of material, each sheet section being adjacent to each other sheet section and each other sheet section such that the strips are cut along common separation 1.

13. The method as recited in claim 9 wherein the strips are cut from the sheet of material by means of a laser beam.

14. The method as recited in claim 9 wherein the second disc is provided with a plurality of recesses each configured to receive a separate encoder.

15. The method as recited in claim 9 wherein at least one of the first disc and the second disc is provided with a plurality of slotted openings.

16. The method as recited claim 15 wherein at least one of the first, second and third rings has a plurality of projections disposed within the slotted openings of the at least one of the first and second discs so as to attach the at least one ring to the at least one disc.

17. The method as recited in claim 9 wherein each one of the first and second discs is substantially coaxial and parallel with respect to the other one of the first and second discs.

18. The method as recited in claim 9 wherein the first ring is fixedly attached to the first disc and each of the second and third rings is fixedly attached to the second disc.

19. The method as recited in claim 9 wherein the first ring is welded to the first disc and the second and third rings are welded to the second disc.

20. The method as recited in claim 9 wherein the sheet of material is sheet metal.
